(19) United States
(12) Patent Application Publication
(10) Pub. No.: US 2005/0137004 A1
(43) Pub. Date: Jun. 23, 2005

(54) Game using objects and reader

(75) Inventors: Michael C. Wood, Orinda, CA (US); Jason Harris, San Francisco, CA (US); Ramon Zamora, Palo Alto, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: LeapFrog Enterprises, Inc., Emeryville, CA (US)

(21) Appl. No.: 10/966,828

(22) Filed: Oct. 15, 2004

Related U.S. Application Data
(60) Provisional application No. 60/512,343, filed on Oct. 17, 2003.

(51) Int. Cl. A63F 13/00

(52) U.S. Cl. 463/11; 273/148 R; 434/156; 273/299

(57) ABSTRACT

An interactive game is disclosed. The interactive game includes a game board, and a plurality of objects, and an electronic apparatus. The electronic apparatus includes an object reader, a processor unit coupled to the card reader, a memory unit coupled to the processor unit, and a speaker coupled to the processor unit. The memory unit comprises code for prompting a player to select an object, and providing an instruction to the player.

### CROSS-REFERENCE TO RELATED APPLICATIONS

This application is a non-provisional of and claims the benefit of the filing date of U.S. patent application Ser. No. 60/512,343, filed on Oct. 17, 2003, which is herein incorporated by reference in its entirety for all purposes.

### BACKGROUND OF THE INVENTION

There are a number of commercially available board games. One commercially available board game for young children is called Candyland™. Candyland™ includes a stack of cards, game pieces, and a game board. Each card contains a colored block printed on it. The colored blocks correspond to colored game piece spaces that form a path on the game board. When playing the game, a player picks a card from the stack of cards. After picking the card, the player moves the player's game piece on the path to the color that is on the card. For example, a player may pick a card with a green block on it. The player then moves the player's game piece forward to the next space that is colored green.

While board games such as Candyland™ are fun to play and somewhat educational, improved board games would be desirable. It would be desirable if a board game could have a greater level of interactivity, while also fostering language development, and motor skills. In Candyland™, for example, the child's interaction with the game is merely one of picking up a card, and moving a game piece according to the color that is printed on the selected card. The game neither reinforces the concept of colors nor teaches other concepts that might be useful to the game players.

Games such as Candyland™ also do not provide rewards for making correct cognitive selections and do not provide educational feedback for incorrect selections. It would be desirable if such feedback could be provided to the players in a board game so that the players can be drilled on those educational concepts that the players need to improve upon. It would also be desirable to provide positive reinforcement for those educational concepts that the players have mastered. All of this would desirably be provided in a fun, and interactive, game environment that encourages game play and learning at the same time.

Embodiments of the invention address these and other problems, individually and collectively.

### SUMMARY OF THE INVENTION

Embodiments of the invention are directed to interactive games, and methods for playing interactive games.

One embodiment of the invention is directed to an interactive game comprising: a game board; a plurality of objects; and an electronic apparatus comprising an object reader, a processor unit coupled to the object reader, a memory unit coupled to the processor unit, and a speaker coupled to the processor unit, wherein the memory unit comprises code for prompting a player to select an object, and then providing an instruction to the player.

Another embodiment of the invention is directed to an interactive game comprising: a game board; a plurality of cards; and an electronic apparatus comprising a card reader, a processor unit coupled to the card reader, a memory unit coupled to the processor unit, and a speaker coupled to the processor unit.

Yet another embodiment of the invention is directed to a method for playing a game, the method comprising: placing a plurality of objects on a game board; selecting an object in the plurality of objects in response to a prompt by an electronic apparatus; using an object reader in the electronic apparatus to read a machine readable code on the selected object; and performing an action in furtherance of the game in response to an instruction provided by the electronic apparatus.

These and other embodiments will be described in further detail below with reference to the Figures.

### BRIEF DESCRIPTIONS OF THE FIGURES

FIG. 1 shows a plan view of components of a game according to an embodiment of the invention.

FIG. 2 shows cards that are used in embodiments of the invention.

FIG. 3 shows a perspective view of an electronic apparatus according to an embodiment of the invention.

FIG. 4 shows a block diagram of some electrical components that can be used in the electronic apparatus.

FIGS. 5(a)-5(c) show exemplary electrical schematics for an electronic apparatus according to an embodiment of the invention.

### DETAILED DESCRIPTION

Embodiments of the invention are directed to interactive board games. In a preferred embodiment, the game can be designed for preschool aged children who are learning letters, colors, shapes and letter sounds. It may be designed for players that are 3 years old or older. In some embodiments, the players need not know how to read in order to play the game. Of course, in other embodiments, older children or even adults can play the interactive board games according to embodiments of the invention.

The board games according to embodiments of the invention can be used to teach the players about any suitable subject(s). For example, in a preferred embodiment, a board game according to an embodiment of the invention can have at least two modes. The at least two modes may include a beginner mode and an advanced mode. In the beginner mode, the board game can be used to teach players about counting, colors, and letters. The beginner mode may be particularly suitable for players 3-4 years old. In the advanced mode, embodiments of the invention can teach children about matching letters to their sounds. The advanced mode may be particularly suitable for players 4-5 years old. Different skill levels for different player ages can thus be provided in embodiments of the invention, so that the board game can “grow” with the player as the player grows older. Further details about game play using these two modes and other modes are provided below.

Although subjects including numbers, colors, and letters are described in detail, embodiments of the invention are not limited to these subjects. It is understood that embodiments of the invention can teach the players about any suitable subject. For example, suitable subjects include subjects such as math (e.g., addition, subtraction, multiplication, and division), language arts, science, history (e.g., natural history), geography, fin facts, social studies, art, spelling, logic, memory improvement, etc.

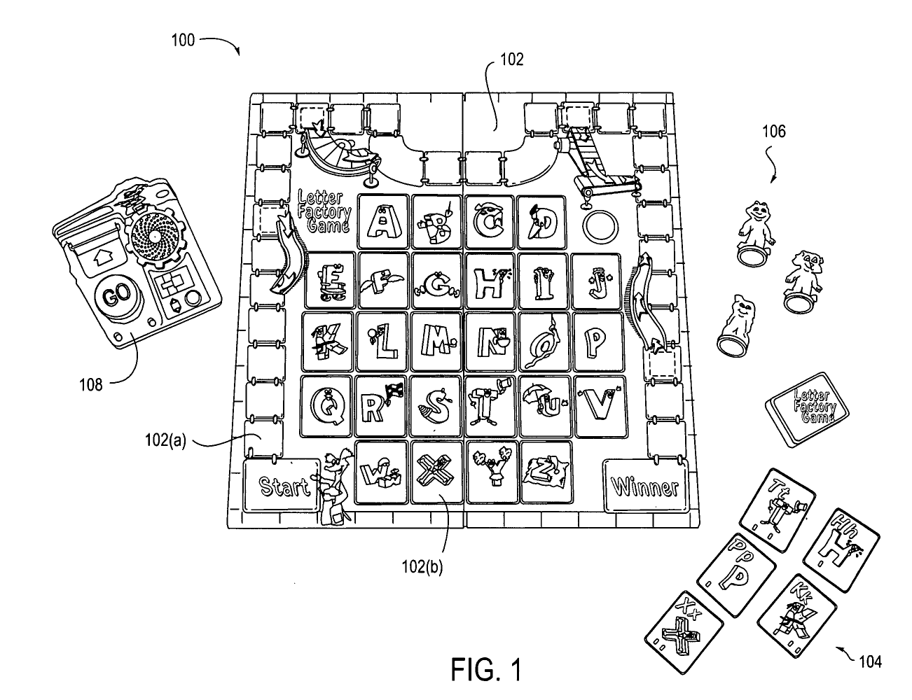

FIG. 1 shows an interactive game 100 according to an embodiment of the invention. The game 100 includes a game board 102, a plurality of objects 104, game pieces 106, and an electronic apparatus 108. The game pieces 106 may comprise molded plastic characters in some embodiments.

The game 100 may have a theme. For example, the game that is illustrated in the FIG. 1 may relate to a fictitious “letter factory” theme whereby letters are made. Various theme characters may be provided to make the game familiar and fun for the players.

The game board 102 can be of any suitable size or configuration. For example, in one embodiment, the game board 102 may be a 21″ by 21″ board that folds, and may comprise standard 80-point plain chipboard. The game board 102 could alternatively be a flexible plastic sheet.

The game board 102 has game spaces 102(a) that provide a path from a starting point to a finish point for the game pieces 106. In some embodiments, the game spaces 102(a) can comprise different colors including orange, red, blue, and purple. Printed images of shortcuts such as slides, stairs, or chutes may be provided on the game board 102 for the players to advance a predetermined number of spaces toward the finish point or retreat a predetermined number of spaces towards the start point.

The game pieces 106 are placed on the game spaces 102(a) and are moved according to instructions provided by the electronic apparatus 108. For example, after a player picks an object 104 and inserts the object 104 into the electronic apparatus 108, a machine readable code on the object 104 is read by an object reader in the electronic apparatus 108. In response, the electronic apparatus 108 may tell the player to move a predetermined number of spaces forward, backward, or not at all (e.g., “Please move five spaces.”).

The game board 102 also includes object receiving regions 102(b) for receiving the plurality of objects 104. In the illustrated embodiment, the object receiving regions 102(a) are printed regions on the game board 100. The printed object receiving regions 102(a) may resemble or correspond to the different objects 104. For example, the objects 104 shown in FIG. 1 are in the form of 26 cards with the letters A-Z respectively printed on them. Likewise, the object receiving regions 102(b) are images of 26 cards with the letters A-Z, respectively. Each object receiving region 102(a) receives a corresponding object 104. As shown in FIG. 1, the letters of the alphabet and their order are displayed to the players to enhance the players' recognition of the letters of the alphabet. In other embodiments, the object receiving regions need not resemble the objects. For example, the object receiving regions could be images of the letters A-Z, without corresponding card images.

The objects 104 may be in any suitable form. In the illustrated embodiment, the objects 104 are cards with the letters A-Z on printed on them. However, in other embodiments, the objects 104 could be two-dimensional disks, three-dimensional blocks, three-dimensional indicia (e.g., three-dimensional letters, numbers, symbols or shapes), three-dimensional figurines, etc. They may be made of any suitable material including plastic, paper, cardboard etc.

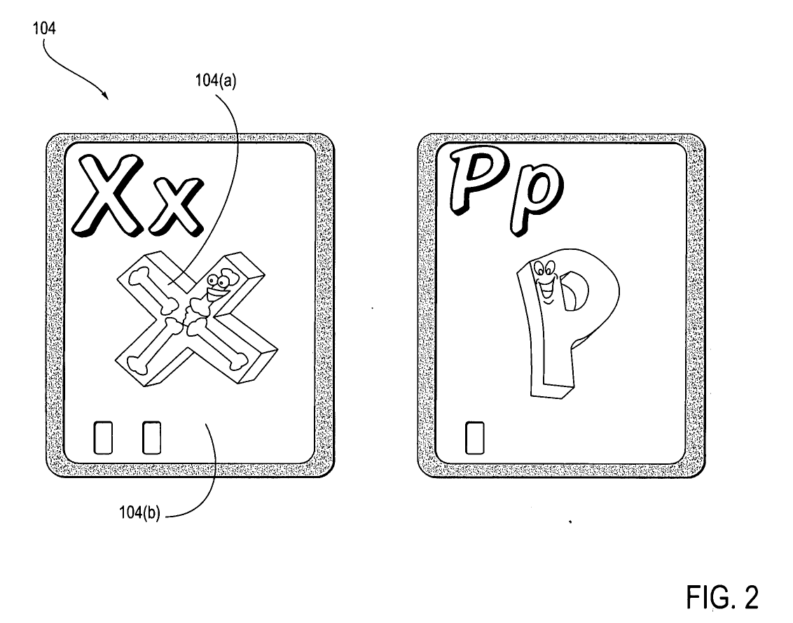

Referring to FIGS. 1 and 2, the objects 104 may also have any suitable printing on them. Preferably, the printed subject matter relates to a particular subject matter to be taught. In the illustrated embodiment, there can be a set of objects where the set of objects includes 26 cards with the letters A-Z on them. In other embodiments, the printed subject matter on the cards may include questions, answers, fin facts, numbers, symbols, etc. For example, FIG. 2 shows two objects 104 in the form of cards according to an embodiment of the invention. Each object 104 includes printed indicia 104(a) on it and a machine readable code 104(b). The printed indicia 104(a) on the first card includes an illustration of an uppercase letter X and a lowercase letter x. The printed indicia 104(a) on the second card includes an illustration of an uppercase letter P and a lowercase letter p. Although letters are shown on the cards, the subject matter printed on the objects may be, for example, numbers, pictures, animals, etc.

Referring to FIGS. 1 and 2, the objects 104 may also include machine-readable codes 104(b), which may correspond to or relate to the subject matter that is printed on the cards and/or the subject matter printed on the object receiving regions. In an embodiment of the invention, a reader in the electronic apparatus 108 may read the machine-readable code on a card and can provide an output related to printed matter that is on the card. For example, the output may relate to the nature of the printed matter on the card, or provide an explanation or a question relating to the printed matter on the card.

As shown in FIG. 2, the machine readable codes 104(b) are in the form of patterns of holes. Although the machine readable codes 104(b) are embodied by patterns of holes in the objects 104 shown in FIG. 2, as will be explained in further detail below, it is understood that embodiments of the invention are not limited thereto as other types of machine readable codes can be used in other embodiments of the invention. In other embodiments, the machine-readable codes on the objects can be bar codes or dot codes that are readable by an optical reader. In yet another embodiment, the machine-readable codes on the objects may be embodied by magnetic strips that can be read by a magnetic reader. A lookup table or the like may be provided in the memory unit in the electronic apparatus 108 so that when the object reader in electronic apparatus 108 reads the machine readable codes 104(b), audio corresponding to the printed indicia 104(b) may be played by the electronic apparatus 108.

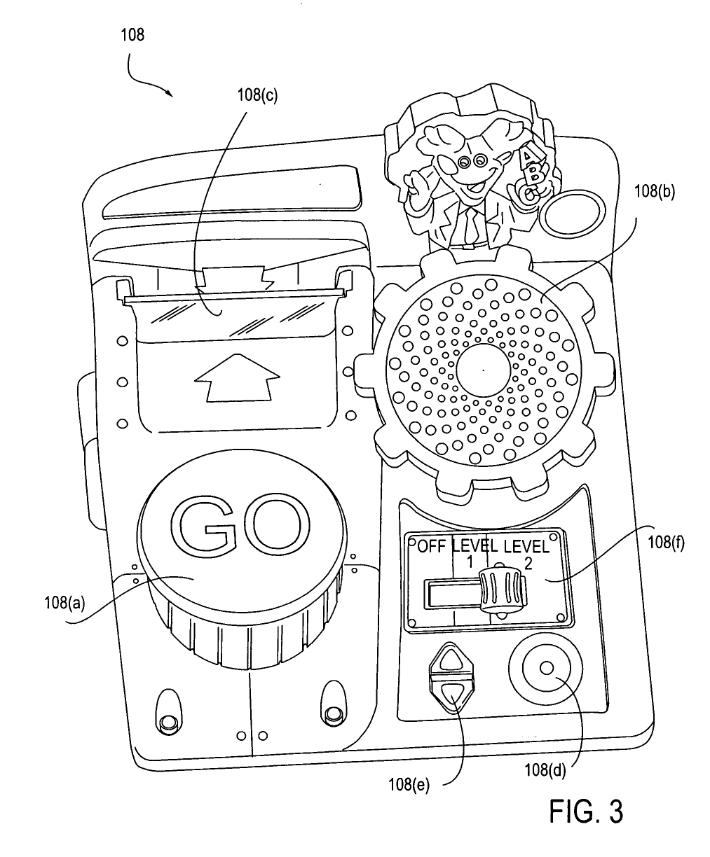

FIG. 3 shows a close-up view of an electronic apparatus 108 according to an embodiment of the invention. The electronic apparatus 108 includes a first input device 108(a). This input device 108(a) may be used to inform the electronics in the electronic apparatus 108 that the player is ready to play the game. It may be in the form of a large “GO” button that can be “slammed” by a player. In one example, the button may be a rubber dometype button with a spring and a 10 mm travel distance (4-5 lb resistive force). A speaker 108(b) (e.g., a paper cone 16 ohm-type speaker) may also be in the electronic apparatus 108 to provide audio outputs for the players.

An object reader 108(c) (e.g., a card reader) is also provided in the electronic apparatus 108. The object reader 108(c) can read the machine-readable codes on the objects 104 that are selected by the players. Consequently, the electronics in the electronic apparatus 108 can tell if the objects selected by the players in response to various prompts are correct or incorrect.

The object reader 108(c) can use any suitable optical, electrical, magnetic, and/or electro-mechanical device to read the machine-readable codes on the objects. As will be shown below, the objects can be cards with patterns of holes in them. These can be read using either optical emitters and optical detectors, or electro-mechanical switches. In the embodiment shown in FIG. 2, the object reader includes a slot for receiving a card.

Other input devices are also present in the electronic apparatus 108. For example, a second input device 108(d) can be provided for informing the electronic apparatus 108 how many players will be playing the game and/or for providing game instructions to the players. A two-position, volume rocker switch 108(e) and a three-position mode switch 108(f) are also present in the electronic apparatus 108. A clue button or input device (not shown) could also be provided to provide the players with clues in case they cannot answer the prompts produced by the electronic apparatus 108 correctly. Alternatively, clues can be provided to the user in response to an incorrect selection of an object (e.g., “The blue cards have the letters O, B, and P on them”).

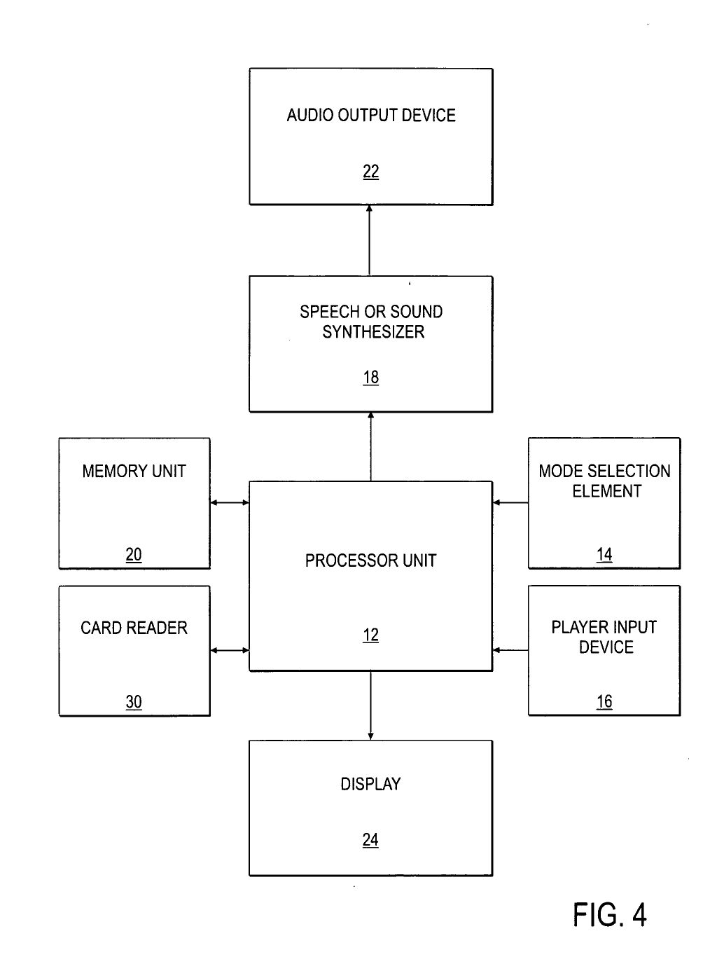

FIG. 4 shows a block diagram of some electronic components that can be used in the electronic apparatus according to an embodiment of the invention. As shown in FIG. 4, a processor unit 12 in the electronic apparatus is coupled to a mode selection element 14 and one or more player input devices 16. The processor unit may comprise an ASIC (application specific integrated circuit). A power source such as standard batteries (not shown) may also be coupled to the processor unit 12. A memory unit 20 may also be electronically coupled to the processor unit 12. Suitable object readers are described in U.S. Pat. No. 5,813,861, which is herein incorporated by reference in its entirety for all purposes.

The memory unit 20 can store computer code for audio outputs and any visual outputs. The audio outputs and/or visual outputs may be in the form of prompts or responses to player inputs. Thus, the memory unit 20 may comprise code for prompting a player to select an object, and code for providing an instruction to the player. The instruction may be to direct the user to move a predetermined number of spaces, pick a card, perform some type of action, etc. In some embodiments, the memory unit 20 may include one or more of a RAM chip, a ROM chip, a CD-ROM, memory card, memory disk, etc.

The memory unit 20 can also store computer code for performing any of the functions of the game. For example, the memory unit 20 may include a lookup table, which correlates various audio outputs to the machine readable codes that are present on the objects selected by the players. The memory unit 20 may also comprise code for causing the electronic apparatus to power down after a pre-determined time of inactivity has elapsed, code for instructions for playing the game, and code for determining how many players there are for playing the game.

Suitable output devices may be provided in the electronic apparatus. For example, to provide audio output for the game, a speech or sound synthesizer 18, and an audio output device 22 such as a speaker or earphone jack can be electrically coupled to the processor unit 12. An optional display 24 may also be electrically coupled to the processor unit 12. The display 24 could be an LCD (liquid crystal display) or one or more LEDs (light emitting diodes). Other components such as speech recognition devices (not shown) may also be coupled to the processor unit 12.

Although various components in FIG. 4 as shown as being separate blocks, it is understood that the electrical components used in embodiments of the invention may be embodied in any number of different forms. For example, the memory unit, the processor unit, and the any speech or sound synthesizing circuitry may be present on one or more computer chips. For instance, commercially available chips from SunPlus, Inc. can be used in embodiments of the invention, and can include a processor, speech synthesizing circuitry, and a memory all in one chip.

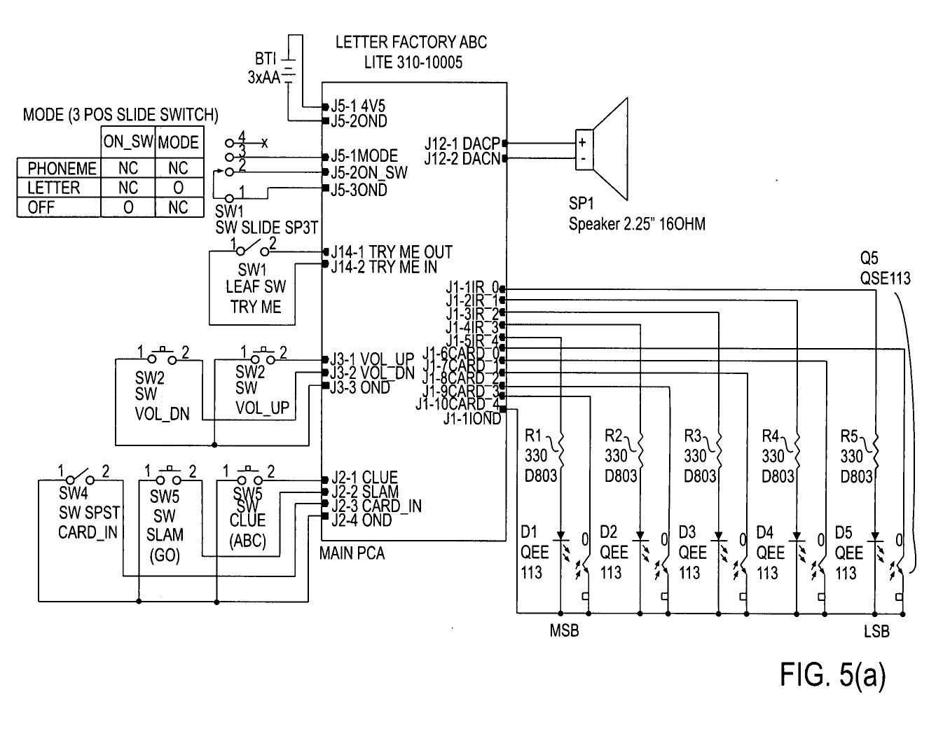

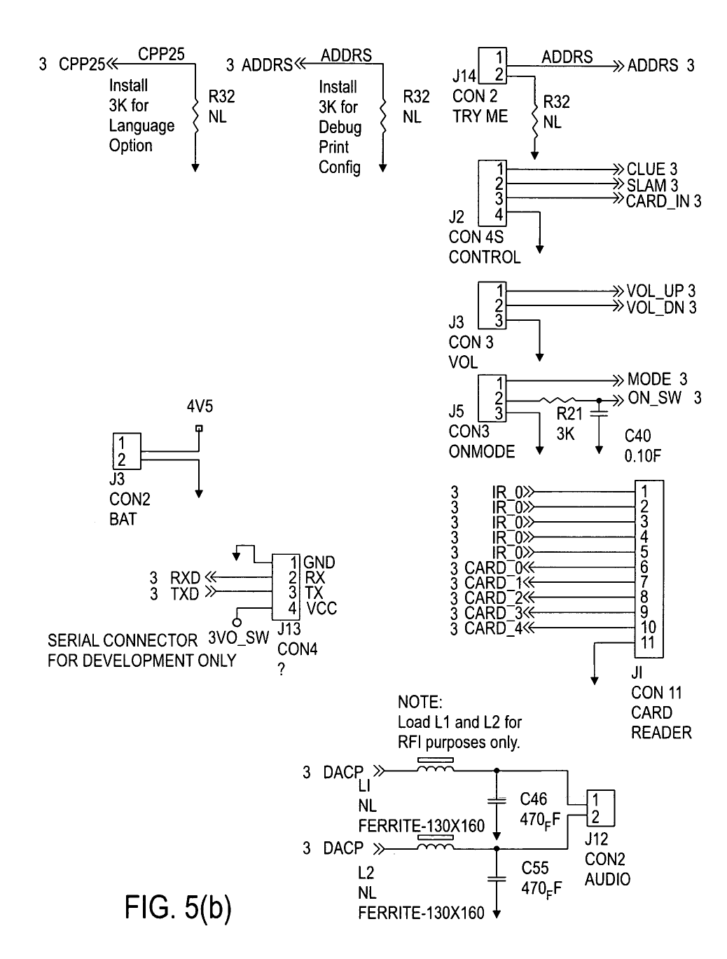

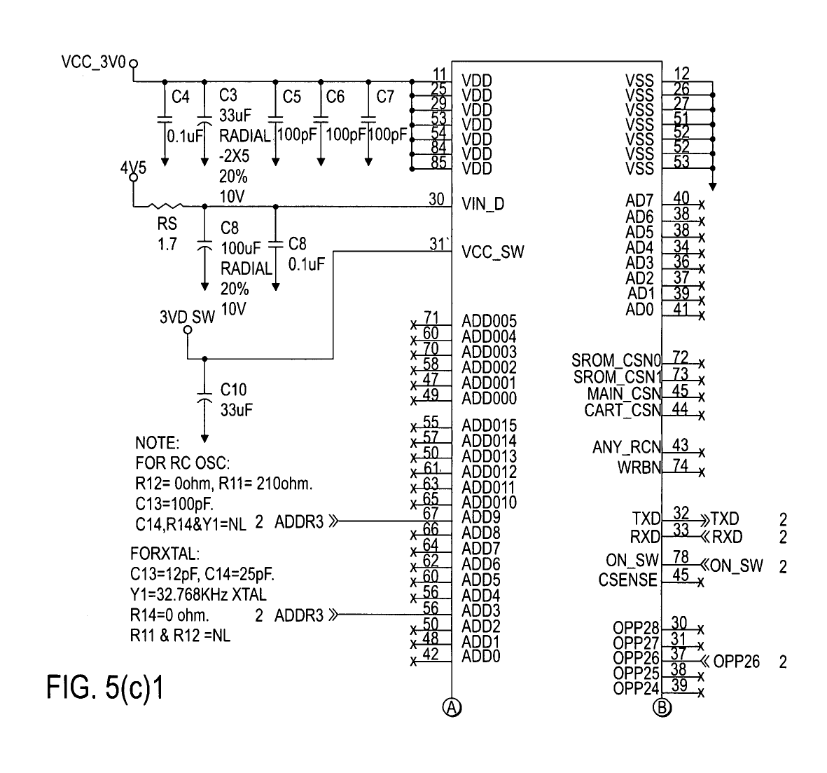

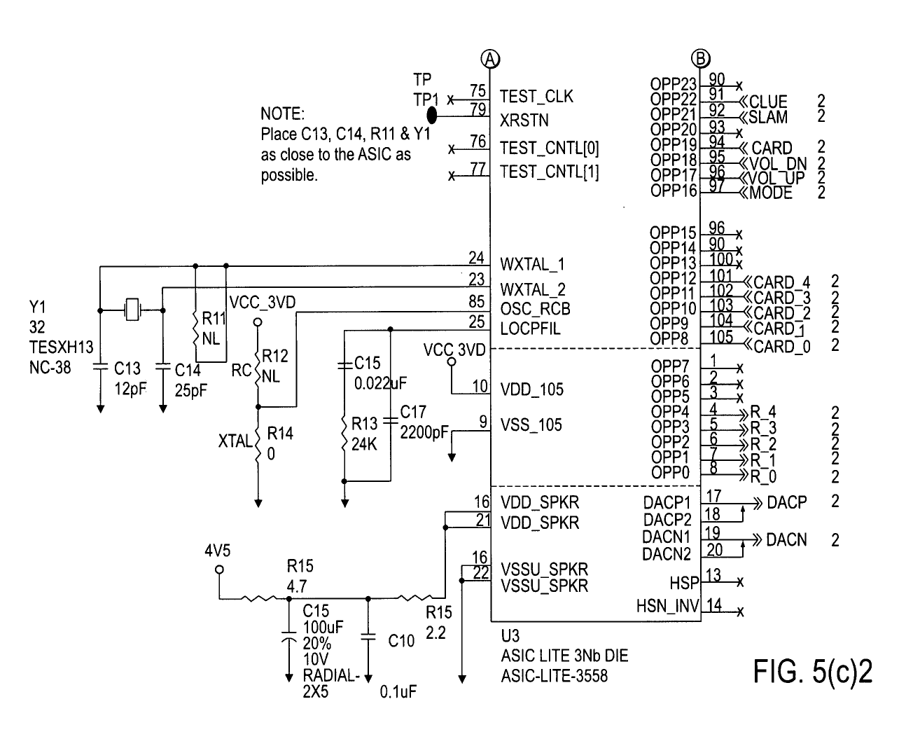

FIGS. 5(a)-5(c) show exemplary electrical schematics for an electronic apparatus according to an embodiment of the invention. It is understood that other electrical schematics could be used in other embodiments of the invention.

Although a specific electronic apparatus is shown and described with respect to FIGS. 3-4, it is understood that embodiments of the invention are not limited thereto. For example, the electronic apparatus may take the form of an optical scanning apparatus including an optical detector, an optical emitter, a memory unit, and an audio output device operatively coupled to a processor unit. The optically scanning apparatus may take the form of a “talking pen”. Such electronic apparatuses are described in further detail in U.S. Patent application Ser. No. 10/803,806, filed on Mar. 17, 2004, and 60/456,053, filed on Mar. 18, 2003, which are herein incorporated by reference in their entirety for all purposes. In this embodiment, the electronic apparatus could scan bar codes, dot codes, etc. Dot codes are described in detail in U.S. Pat. Ser. Nos. 6,570,104 and 6,548,768. Paper including dot codes is commercially obtainable from Anoto AB of Sweden. In such embodiments, substantially invisible dot codes can be printed over or under print elements (e.g., letters, numbers, etc.) on the game board or objects (e.g., cards). The dot codes can be scanned and appropriate audio outputs can be provided to the players.

### Interactive Game Play

Other embodiments of the invention are directed to methods for playing games. The method includes placing a plurality of objects such as cards on a game board. After the objects are on the game board, a player selects an object from the game board in response to a prompt by an electronic apparatus. An object reader in the electronic apparatus then reads the object, and an instruction is provided to the player by the electronic apparatus. The instruction may be to move the player's game piece a particular number of spaces forward, backward, or not at all. The nature of the instruction may depend upon whether the selected object is correctly or incorrectly selected. For example, a wrong object selection may result in the player not moving his game piece forward, while a correct selection may result in the player moving his game piece forward. After performing the task requested by the electronic apparatus, the player then places the selected object back on the game board, and the next player takes a turn. This process can be repeated until one of the players finishes the game by arriving at the finish point on the game board.

An exemplary game play process for the embodiments illustrated in FIGS. 1-3 is provided below. It is understood that embodiments of the invention are not limited to the described game play process, and it is understood that embodiments of the invention are not limited to a game play process including all of the mentioned steps in the recited order. For example, embodiments of the invention may include any suitable combination of the noted steps and need not include all steps and need not be present in the recited order. Further details regarding game play processes are described in U.S. provisional patent application Ser. No. 60/512,343, filed on Oct. 17, 2004, which is herein incorporated by reference in its entirety for all purposes.

1. The players move mode switch 108(f) to Level 1 (Counting, Colors, and Letters) or Level 2 (Letter Match).

2. Assuming that the players have chosen Level 1, the electronic apparatus 108 may then instruct the players to “Put each letter, letter side up, on its matching place on the game board with the letters facing up. When you are done, press the green ‘Go’ button.” The players then place the cards on the game board as instructed and then press the “Go” button 108(a).

3. The electronic apparatus 108 then instructs the players to “Place the characters on the ‘start’ space, and use the orange button (108(d)) to select the number of players.” The players then do as instructed, and the orange button 108(d) is pressed twice for two players, three times for three players, etc.

4. To inform the electronic apparatus 108, that the previous steps have been completed, the “Go” button 108(a) is depressed to start the game.

5. Then, the electronic apparatus 108 asks player 1 to “Pick a blue letter card, and put it in the Letter Machine. Put the card in so that you can read the letter.” The card is then visible to the players. If the player picks an incorrect letter card such as the orange letter E from the board and places it in the electronic apparatus 108, it may say “That's an orange letter. Please put the E card back on the game board and please pick a blue letter card. The letters Q, R, S, and T are on the blue letter cards.” Thus, if the player inserts a correct color card, the electronic apparatus will sound out the letter that appears on the card, say how it is used in a word, and/or play a song about the letter. If the incorrect card is inserted, the electronic apparatus will inform the player that the player inserted the card incorrectly and will ask the player to try again. The incorrect letter card is then put back on the game board, and the player tries again. The player may get two more tries to pick the correct color or letter card. If the player does not pick the correct card within a predetermined number of tries (e.g., one try or two tries), then that player may not get to advance the player's game piece forward.

6. If the player then selects the blue letter Q and places it in the electronic apparatus 108, the electronic apparatus 108 says “That's a color match! A blue letter Q. Let's count as you move. Move ahead six spaces. One, two, three, four, five, six! The space you land on is Yellow. Put the Q letter card back on the factory floor.” As illustrated, in embodiments of the invention, the player listens for audio from the electronic apparatus to determine how many spaces to move the player's game piece on the board. If the player selects the correct card, the player gets to move the player's game piece forward toward the finish point. During gameplay, it might be possible to land on a “slide” to go forward or backward. For example, landing on a particular game space may allow the player to move forward an extra five spaces. In addition, as illustrated in this step, the electronic apparatus 108 can also “track” the movement of each of the players in the game, since the electronic apparatus 108 provides the number of spaces that each player moves and also has information regarding the game piece spaces in its memory unit. Accordingly, in embodiments of the invention, the electronic apparatus 108 can not only provide instructions to a player on how many spaces to move a game piece, but can also provide feedback as to the particular space that the player has landed on.

7. After player 1 has taken a turn, the card is taken out of the electronic apparatus and it is returned to its matching space on the game board.

8. Game play continues until one player reaches the winner space. Other players may continue to play until they too reach the winner space.

9. Various other features may be programmed into the electronic apparatus. For example, when a player takes a turn, the electronic apparatus 108 may inform the player that there is a “factory breakdown” where the player loses a turn, or that there is a “rush order” whereby the player gets a free turn. There can also be a bonus play where the player will be asked to make a letter sound, say a word that starts with the letter or point out an object that starts with the letter. All of the players may be asked to dance or make a funny sound.

The game process described above is for the counting, colors, and letters mode. A second mode can be a letter matching mode. In this mode, the electronic apparatus 108 may ask the player a question such as “Find the letter P as in ‘pop’ and put the letter card in.” or “What letter comes after the letter O?” If the player puts the card with the letter “P” in the electronic apparatus, the electronic apparatus may inform the user to move a predetermined number of spaces forward. Then a song, or educational message (e.g., “The letter P, says puh!”) may be played. If the player selects the card with the wrong letter, then the user may be asked to put the card back on the game board and to try again.

Embodiments of the invention have a number of advantages. As illustrated above, the game embodiments of the invention can reinforce concepts such as counting, numbers, letters, and colors during a single turn of the game. In addition, since the electronic apparatus 108 “remembers” where a player's game piece will land after each turn, reinforcing audio feedback can be provided to supplement the visual feedback provided by the game board, game objects, and game pieces. Thus, embodiments of the invention promote language development, cognitive development, and motor skills. Language skills are developed as children are introduced to the names and sounds of each letter in the alphabet, as well as colors and counting. Children can develop important cognitive and social skills by playing interactive, multiplayer learning games. Lastly, children practice hand-eye coordination as they place letter cards into the electronic apparatus and on the game board.

The terms and expressions which have been employed herein are used as terms of description and not of limitation, and there is no intention in the use of such terms and expressions of excluding equivalents of the features shown and described, or portions thereof, it being recognized that various modifications are possible within the scope of the invention claimed.

Moreover, any one or more features of any embodiment of the invention may be combined with any one or more other features of any other embodiment of the invention, without departing from the scope of the invention.

All patent applications, patents, and publications mentioned above are herein incorporated by reference in their entirety for all purposes. None is admitted to be prior art.

1. A interactive game comprising:
a game board;
a plurality of objects; and
an electronic apparatus comprising an object reader, a processor unit coupled to the object reader, a memory unit coupled to the processor unit, and a speaker coupled to the processor unit, wherein the memory unit comprises code for prompting a player to select an object, and then providing an instruction to the player.

2. The interactive game of claim 1 wherein the object reader is a card reader.

3. The interactive game of claim 1 wherein the object reader is a card reader and the objects are cards, and wherein the cards include images and machine readable codes.

4. The interactive game of claim 1 wherein the instruction is an instruction to move a game piece a particular number of spaces.

5. The interactive game of claim 1 further comprising a plurality of game pieces.

6. The interactive game of claim 1 wherein the game is adapted to teach players of the game about letters, phonics, colors, and numbers.

7. The interactive game of claim 1 wherein the game is adapted to teach the user about letters, phonics, colors, or numbers.

8. The interactive game of claim 1 the game board comprises a number of object receiving regions for placement of the objects.

9. The interactive game of claim 1 wherein the electronic apparatus further comprises a mode switch.

10. A interactive game comprising:
a game board;
a plurality of cards; and
an electronic apparatus comprising a card reader, a processor unit coupled to the card reader, a memory unit coupled to the processor unit, and a speaker coupled to the processor unit.

11. The interactive game of claim 10 wherein the plurality of cards include the letters A-Z respectively.

12. The interactive game of claim 10 wherein the electronic apparatus includes a clue button.

13. The interactive game of claim 10 wherein the electronic apparatus includes a multimode switch.

14. The interactive game of claim 10 wherein the game board comprises a plurality of separate object receiving regions respectively corresponding to the plurality of cards, and wherein one card in the plurality of cards is placed on one receiving region in the plurality of receiving regions.

15. The interactive game of claim 10 wherein the game board comprises a plurality of separate receiving regions respectively corresponding to the plurality of cards, wherein one card in the plurality of cards is placed on one receiving region in the plurality of receiving regions, and wherein the plurality of cards include the letters A-Z, respectively, and the plurality of receiving regions comprise the letters A-Z, respectively.

16. The interactive game of claim 10 wherein the memory unit comprises code for prompting the user to select a particular card, and code for providing an instruction to the user after the user has selected the particular card.

17. The interactive game of claim 10 wherein the memory unit comprises code for prompting the user to select a card, code for informing a player of the game to move the player's game piece a number of spaces after the user has the card reader read the card, and code for informing the user about a characteristic relating to the space that the player's game piece will reside on after the user has moved the game piece the number of spaces.

18. A method for playing a game comprising:
placing a plurality of objects on a game board;
selecting an object in the plurality of objects in response to a prompt by an electronic apparatus;
using an object reader in the electronic apparatus to read a machine readable code on the selected object; and
performing an action in furtherance of the game in response to an instruction provided by the electronic apparatus.

19. The method of claim 18 wherein the object is a card.

20. The method of claim 18 wherein the machine-readable code comprises holes in the object.

21. The method of claim 18 wherein the instruction is an instruction to move a game piece a particular number of spaces.

22. The method of claim 18 further comprising, after performing the action, placing the selected object back on the game board.

23. The method of claim 18 wherein the game board comprises a plurality of object receiving regions for respectively receiving the plurality of objects.

24. The method of claim 18 wherein the game is adapted to teach players of the game about letters, phonics, colors, and numbers.

25. The method of claim 18 wherein the objects are cards having the letters A-Z, each card including a machine readable code corresponding to the letter on the card.

26. The method of claim 18 wherein the game board comprises a plurality of object receiving regions, and a plurality of game-piece spaces, and wherein the game further includes a number of game pieces that are manipulated by the players of the game after instruction by the electronic apparatus.

27. The method of claim 18 wherein the electronic apparatus recites a characteristic of the object if the wrong object is selected, wherein the electronic apparatus further prompts the user to select another object if the wrong object is selected, and wherein the electronic apparatus provides a second instruction after the user selects the correct object from the plurality of objects.
